(19) United States
(12) Patent Application Publication
(10) Pub. No.: US 2007/0240174 A1
(43) Pub. Date: Oct. 11, 2007

(54) Apparatus and method for receiving a portable media player to perform an accessory function

(75) Inventors: Bryan Lee Hynecek, Plano, TX (US); Jon Karl Dukerschein, Addison, TX (US)

Correspondence Address: LAW OFFICE OF DONALD D. MONDUL, 3060 Bonsai Drive, Plano, TX, 75093, US

(73) Assignee: RadioShack Corporation

(21) Appl. No.: 11/378,525

(22) Filed: Mar. 18, 2006

(51) Int. Cl. G11B 33/02

(52) U.S. Cl. 720/600

(57) ABSTRACT

An apparatus configured for receiving a portable media player unit to cooperatively perform an accessory function with the player unit in a connected orientation contains at least a portion of an accessory unit. The portable media player unit presents an electrical connector structure. The apparatus includes: (a) a connecting structure for effecting electrical connecting with the electrical connector structure to establish the connected orientation; and (b) a receiving structure configured for supporting the player unit when the apparatus and the player unit are in the connected orientation. The connector unit is movable with respect to the apparatus to accommodate various orientations of the electrical connector structure presented by various models of the player unit in the connected orientation.

### BACKGROUND OF THE INVENTION

The present invention is directed to accessory units for use with portable media player devices, and especially to accessory units electrically coupling with portable media player devices to provide additional capability for the coupled portable media player device.

Portable media player devices, including by way of example and not by way of limitation MP3 players, iPOD devices (product and Reg. Trademark of Apple Corporation) and other analog and digital devices, are sometimes coupled with add-on apparatuses to enhance or add to the capabilities of the portable media player device. Such coupling is often effected by a male-female plugging arrangement with one of the male-female plug units being affixed with one of the portable media player device and the accessory device, and the other of the male-female plug units being affixed with the remaining device of the portable media player device and the accessory device. This is essentially a simple arrangement so long as the male plug portion and the female plug portion can be easily aligned for carrying out the desired coupled arrangement or orientation.

By way of example and not by way of limitation, accessory devices may include portable stereo or “boom box” units for providing enhanced audio output from a portable media player device, an alarm unit for providing an alarm function for a portable media player device, a video unit for providing enhanced video or video and audio output from a portable media player device or a combination of such accessory units, or accessory features or capabilities.

Some manufacturers have offered portable media player products that have a plug coupling unit that is offset from the center of the player. This plug component offset may be necessary to accommodate another plug on the portable media player case, such as a headphone plug component, or such a plug component offset may be required or desired for another reason. As a result of such a plug component offset, one ends up with an off-center located portable media player device when it is in a coupled relation with an accessory unit. The portable media player device and the accessory unit appear misaligned when assembled in a connected orientation. In a worst case, the portable media player device may not be able to correctly align with the accessory unit to establish the connected relation required for proper operation.

There is a need for an apparatus and method for receiving a portable media player device with an accessory unit to perform an accessory function, especially when the portable media player device has an off-center plug component provided for coupling with the accessory unit.

### SUMMARY OF THE INVENTION

An apparatus configured for receiving a portable media player unit to cooperatively perform an accessory function with the player unit in a connected orientation contains at least a portion of an accessory unit. The portable media player unit presents an electrical connector structure. The apparatus includes: (a) a connecting structure for effecting electrical connecting with the electrical connector structure to establish the connected orientation; and (b) a receiving structure configured for supporting the player unit when the apparatus and the player unit are in the connected orientation. The connector unit is movable with respect to the apparatus to accommodate various orientations of the electrical connector structure presented by various models of the player unit in the connected orientation.

A method for configuring a receiving apparatus and a portable media player device to cooperatingly perform an accessory function, the apparatus containing at least a portion of an accessory unit, includes the steps of: (a) in no particular order: (1) providing an aligning structure for positioning the portable media player device for effecting a connected orientation; and (2) providing a movable connecting structure for electrically connecting the portable media player device with the apparatus in the connected orientation;(b) in no particular order: (1) orienting the connecting structure to an operating locus for effecting the electrical connecting with an extant model of the portable media device; and (2) orienting the portable media player device with respect to the aligning structure in a locus poised for effecting the connected orientation; and (c) urging the portable media player device and the apparatus together to establish the connected orientation. The portable media player device cooperates with the apparatus to perform the accessory function when in the connected orientation.

It is, therefore, an object of the present invention to provide an apparatus and method for receiving a portable media player device with an accessory unit to perform an accessory function, especially when the portable media player device has an off-center plug component provided for coupling with the accessory unit.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a front view of a first exemplary accessory unit configured according to the present invention.

FIG. 2 is a top view of the first exemplary accessory unit illustrated in FIG. 1.

FIG. 3 is a rear view of the first exemplary accessory unit illustrated in FIG. 1.

FIG. 4 is a perspective view of the exemplary accessory unit illustrated in FIG. 1, with a portable player unit poised for engaging the accessory unit.

FIG. 5 is a flow chart illustrating the method of the present invention.

FIG. 6 is a perspective view of a second exemplary accessory unit configured according to the present invention.

FIG. 7 is a perspective view of a portion of the second exemplary accessory unit illustrated in FIG. 6 with the door opened.

### DETAILED DESCRIPTION OF THE PREFERRED EMBODIMENT

The term “locus” is intended herein to indicate a place, location, locality, locale, point, position, site, spot, volume, juncture, junction or other identifiable location-related zone in one or more dimensions. A locus in a physical apparatus may include, by way of example and not by way of limitation, a corner, intersection, curve, line, area, plane, volume or a portion of any of those features. A locus in an electrical apparatus may include, by way of example and not by way of limitation, a terminal, wire, circuit, circuit trace, circuit board, wiring board, pin, connector, component, collection of components, sub-component or other identifiable location-related area in one or more dimensions. A locus in a flow chart may include, by way of example and not by way of limitation, a juncture, step, site, function, query, response or other aspect, step, increment or an interstice between junctures, steps, sites, functions, queries, responses or other aspects of the flow or method represented by the chart.

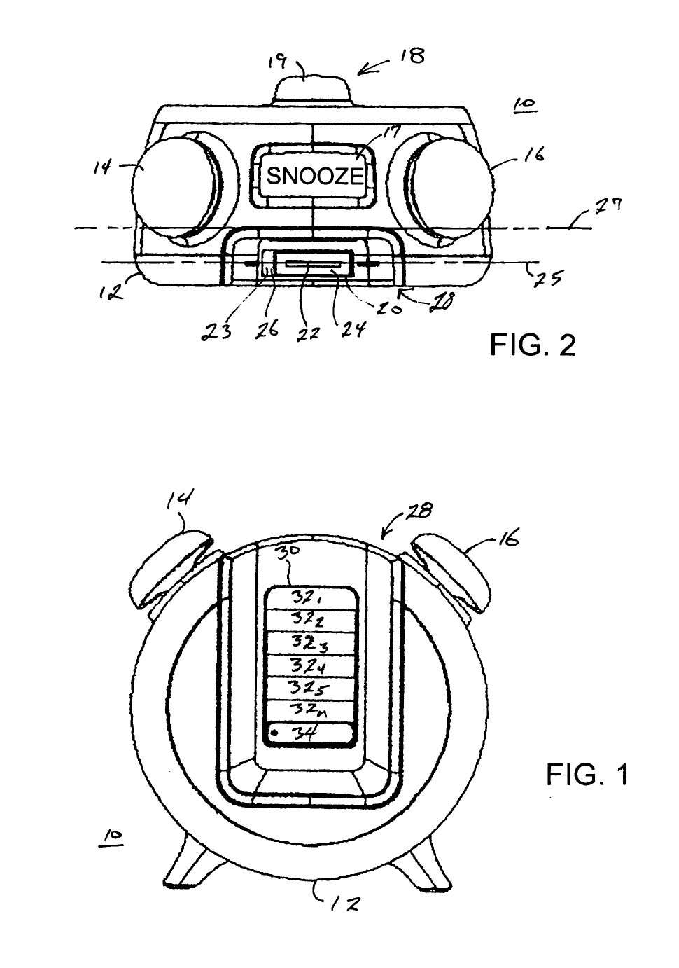

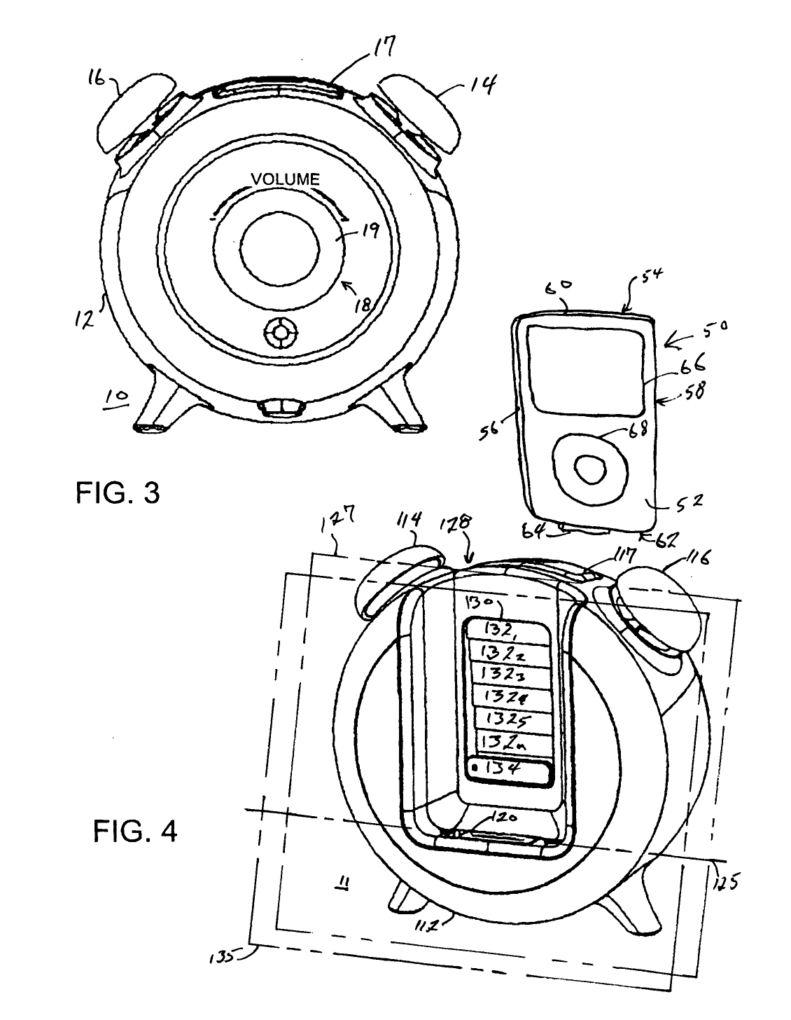

FIG. 1 is a front view of a first exemplary accessory unit configured according to the present invention. FIG. 2 is a top view of the first exemplary accessory unit illustrated in FIG. 1. FIG. 3 is a rear view of the first exemplary accessory unit illustrated in FIG. 1. Regarding FIGS. 1-3 together, an accessory apparatus or unit 10 is configured to perform an alarm function in cooperation with a portable media player device (not shown in FIGS. 1-3). Accessory apparatus 10 includes a body portion 12 and alarm indicators 14, 16. Alarm indicators 14, 16 are embodied in bells for accessory apparatus 10. Alternatively, alarm indicators 14, 16 could be embodied in other configurations not shown in FIGS. 1-3 such as, by way of example and not by way of limitation, chimes, lights, sirens, a clock radio, a disc or tape player or another alert medium or device.

Accessory apparatus 10 also includes a volume control actuator 18 (best viewed in FIGS. 2 and 3), embodied in a rotating knob 19. Other controls may be provided (not shown in FIGS. 1-3) depending upon the accessory function being performed by accessory apparatus 10. In the exemplary accessory apparatus 10 of FIGS. 1-3, an alarm function may require a “SNOOZE” button 17 for temporarily interrupting an alarm signal provided by alarm indicators 14, 16.

Body portion 12 includes a connecting structure 20 (best seen in FIG. 2). Connecting structure 20 is embodied in an electrical connecting structure presenting a plurality of pins-or-sockets 22 (represented by a rectangle 22 in FIG. 2) slidingly mounted in a slot 23. Pins-or-sockets 22 are arranged to facilitate a mating relationship with a complementary connecting structure presented by a portable media player device (not shown in FIGS. 1-3). Pins-or-sockets 22 and the complementary connecting structure of the portable media player device cooperate to engage in a connected orientation in order to establish an electrical connection between accessory apparatus 10 and the portable media player device. A variety of appropriate pins-or-sockets 22 configurations for carrying out the arrangement required for effecting electrical coupling for the present invention are available and known to those skilled in the art. Pins-or-sockets 22 may be embodied in pins, embodied in sockets or embodied in a combination of pins and sockets as required for establishing an electrical connected or coupled orientation with a complementary connector structure provided for a portable media player device. A novel feature of the present invention is that pins-or-sockets 22 are carried on a shuttle unit 24 that is movable within a slot 23 between a right-hand-most position (illustrated in FIG. 2) by which a gap 26 is present between shuttle unit 24 and body portion 12 at the left end of slot 23 in FIG. 2, and a left-hand-most position by which a gap would be left between the right end of shuttle unit 24 and body portion 12 at the right end of slot 23 in FIG. 2. Shuttle unit 24 may be mounted with body portion 12 to provide an analog or continuous positioning capability of shuttle unit 24 anywhere between its right-hand-most position (illustrated in FIG. 2) and its left-and-most position. Alternatively, shuttle unit 24 may be mounted with body portion 12 to provide discrete positioning capability of shuttle unit 24 between its right-hand-most position (illustrated in FIG. 2) and its left-and-most position to provide predetermined loci at which shuttle 24 may be oriented for connecting with a portable media player device. Such discrete positioning may be provided using a detent interference fit between shuttle unit 24 and body portion 12 or using another known discrete positioning arrangement.

Body portion 12 includes a receiving structure 28 (best seen in FIGS. 1-2). Receiving structure 28 preferably provides a cradling structure configured to nestingly hold a portable media player device (not shown in FIGS. 1-2) in a coupling relation with connecting structure 20 when the portable media player device is in a coupled orientation with accessory apparatus 10. Substantial alignment between pins-or-sockets 22 and a complementary connector structure provided for a portable media player device (not shown in FIGS. 1-3) contributes to solidity of coupling between apparatus 10 and a portable media player device. Moving pins-or-sockets 22 within slot 23 affects alignment along a longitudinal axis 25 of slot 23. Positioning of a portable media player device within an alignment plane generally perpendicular with pins-or-sockets 22 and containing axis 25 further contributes to better alignment and more solidity of coupling between apparatus 10 and a portable media player device.

An attitude adjustment structure 30 (best seen in FIG. 1) is provided to effect generally aligning a portable media player device vertically with pins-or-sockets 22 for establishing a connected orientation between apparatus 10 and a portable media player device. Attitude adjustment structure 30 includes a plurality of stepped elements 32₁, 32₂, 32₃, 32₄, 32₅, 32ₙ and an adjustment selecting element 34. The indicator “n” is employed to signify that there can be any number of stepped elements in attitude adjustment structure 30. The inclusion of six stepped elements 32ₙ in FIG. 1 is illustrative only and does not constitute any limitation regarding the number of stepped elements that may be included in the attitude adjustment structure of the present invention. Each respective stepped element 32ₙ is configured to extend a respective distance from a reference plane 27 toward an alignment plane that is generally perpendicular with pins-or-sockets 22 and contains axis 25. Reference plane 27 is generally parallel with the alignment plane. Adjustment selection element 34 is configured to be placed by a user in a position generally adjacent to a selected stepped element 32ₙ to establish a respective resting support situated a respective distance from reference plane 27. The respective resting support supportingly rests against a face of an installed portable media player device that is in a connected orientation with apparatus 10 within receiving structure 28 and engaged with connection structure 20. By way of example and not by way of limitation, adjustment selection element 34 may be configured for removable snap-fit by a user with body portion 12 to fix adjustment selection element 34 adjacent to a respective stepped element 32ₙ. By way of further example and not by way of limitation, adjustment selection element 34 may be configured for a detented sliding adjustment capability to fix adjustment selection element 34 adjacent to a respective stepped element 32ₙ.

Stepped elements 32₁, 32₂, 32₃, 32₄, 32₅, 32ₙ are generally oriented above slot 23 so as to perform an attitude adjustment function for a coupled portable media player device regardless of what position shuttle unit 24 occupies within slot 23. A user may position adjustment selection element 34 adjacent to a particular stepped element 32ₙ that most closely supports a particular model of portable media player device in the desired orientation between the portable media player device and pins-or-sockets 22 for a good connected orientation.

FIG. 4 is a perspective view of the exemplary accessory unit illustrated in FIG. 1, with a portable player unit poised for engaging the accessory unit. In FIG. 4, an accessory apparatus or unit 11 is illustrated with a portable media player unit 50 poised for assembly in a connected orientation with accessory apparatus 11. Portable media player device 50 is generally polyhedral or parallelepiped in shape having a front face 52, a rear face 54, sides 56, 58, a top 60 and a bottom 62. A display 66 and operating controls 68 are provided at front face 152. A connecting structure 64 is provided at bottom 62.

Accessory apparatus 11 is configured to perform an alarm function in cooperation with portable media player device 50. Accessory apparatus 11 includes a body portion 112 and alarm indicators 114, 116. Alarm indicators 114, 116 are embodied in bells for accessory apparatus 11. Alternatively alarm indicators 114, 116 could be embodied in other configurations such as, by way of example and not by way of limitation, chimes, lights, sirens, a clock radio, a disc or tape player or another alert medium or device.

Accessory apparatus 11 may also include a volume control actuator embodied in a rotating knob (see actuator 18, knob 19; FIGS. 2 and 3). Other controls may be provided depending upon the accessory function being performed by accessory apparatus 11. In the exemplary accessory apparatus 11, an alarm function may require a “SNOOZE” button 117 for temporarily interrupting an alarm signal provided by alarm indicators 114, 116.

Body portion 112 includes a connecting structure 120. Connecting structure 120 is substantially similar to connecting structure 20 (best seen in FIG. 2). In order to avoid prolixity and to avoid cluttering FIG. 4, a detailed description of connecting structure 120 will not be provided here. Description of connecting structure 20 provided in connection with FIGS. 1-2 is considered sufficient for one skilled in the art to use for reproducing connecting structure 120 without undue experimentation.

Body portion 112 includes a receiving structure 128. Receiving structure 128 preferably provides a cradling structure configured to nestingly hold portable media player device 50 in a coupling relation with connecting structure 120 when portable media player device 50 is in a coupled orientation with accessory apparatus 11. Connecting structure 64 of portable media player device 50 is configured with appropriate pins and sockets (not shown in FIG. 4) to engage in a complementary mating relation with connecting structure 120 for completing a connected orientation with apparatus 11. Connecting structure 64 may be configured to be substantially flush with bottom 62 of portable media player device 50 rather than extending from portable media player device 50 as shown in FIG. 4.

Substantial alignment between connecting structure 120 and a complementary connecting structure 64 provided for portable media player device 50 contributes to solidity of coupling between apparatus 11 and portable media player device 50. Moving connecting structure 120 along a longitudinal axis 125 (refer to detailed description of connecting structure 20; FIG. 2) aligns connecting structure 120 along axis 125. Positioning of portable media player device 50 within an alignment plane 135 generally perpendicular with connecting structure 120 and containing axis 125 further contributes to solidity of coupling between apparatus 11 and portable media player device 50.

An attitude adjustment structure 130 is provided to effect generally aligning portable media player device 50 vertically with connecting structure 120 for establishing a connected orientation between apparatus 11 and portable media player device 50. Attitude adjustment structure 130 includes a plurality of stepped elements 132₁, 132₂, 132₃, 132₄, 132₅, 132ₙ and an adjustment selecting element 134. The indicator “n” is employed to signify that there can be any number of stepped elements in attitude adjustment structure 130. The inclusion of six stepped elements 132ₙ in FIG. 4 is illustrative only and does not constitute any limitation regarding the number of stepped elements that may be included in the attitude adjustment structure of the present invention. Each respective stepped element 132ₙ is configured to extend a respective distance from a reference plane 127 toward alignment plane 135. Reference plane 127 is generally parallel with alignment plane 135. Adjustment selection element 134 is configured to be placed by a user in a position generally adjacent to a selected stepped element 132ₙ to establish a respective resting support for a face of the installed portable media player device within receiving structure of connection with connection structure 120. By way of example and not by way of limitation, one may observe in FIG. 4 that stepped element 132₅ is displaced further toward alignment plane 125 from reference plane than stepped element 132ₙ, stepped element 132₄ is displaced further toward alignment plane 125 from reference plane than stepped element 132₅, stepped element 132₃ is displaced further toward alignment plane 125 from reference plane than stepped element 132₄, stepped element 132₂ is displaced further toward alignment plane 125 from reference plane than stepped element 132₃ and stepped element 132₁ is displaced further toward alignment plane 125 from reference plane than stepped element 132₂. By way of example and not by way of limitation, adjustment selection element 134 may be configured for removable snap-fit orientation adjacent to a respective stepped element 132ₙ by a user to establish a support for back side 54 of portable media player device 50 in a connected orientation with apparatus 11. Placing adjustment selection element 134 adjacent to stepped element 132₅ will support portable media player device 50 a further distance from reference plane 127 than if adjustment selection element 134 is placed adjacent to stepped element 132ₙ. Placing adjustment selection element 134 adjacent to stepped element 132₄ will support portable media player device 50 a further distance from reference plane 127 than if adjustment selection element 134 is placed adjacent to stepped element 132₅. Placing adjustment selection element 134 adjacent to stepped element 132₃ will support portable media player device 50 a further distance from reference plane 127 than if adjustment selection element 134 is placed adjacent to stepped element 132₄. Placing adjustment selection element 134 adjacent to stepped element 132₂ will support portable media player device 50 a further distance from reference plane 127 than if adjustment selection element 134 is placed adjacent to stepped element 132₃. Placing adjustment selection element 134 adjacent to stepped element 132₁ will support portable media player device 50 a further distance from reference plane 127 than if adjustment selection element 134 is placed adjacent to stepped element 132₂.

Stepped elements 132₁, 132₂, 132₃, 132₄, 132₅, 132ₙ are generally symmetrically oriented above connecting structure 120 so as to perform an attitude adjustment function for portable media player device 50 regardless of what position connecting structure 120 occupies along axis 125. A user may position adjustment selection element 34 adjacent to a particular stepped element 32ₙ that most closely supports a particular model of portable media player device 50 in a desired orientation between portable media player device 50 and connecting structure 120 for a good connected orientation.

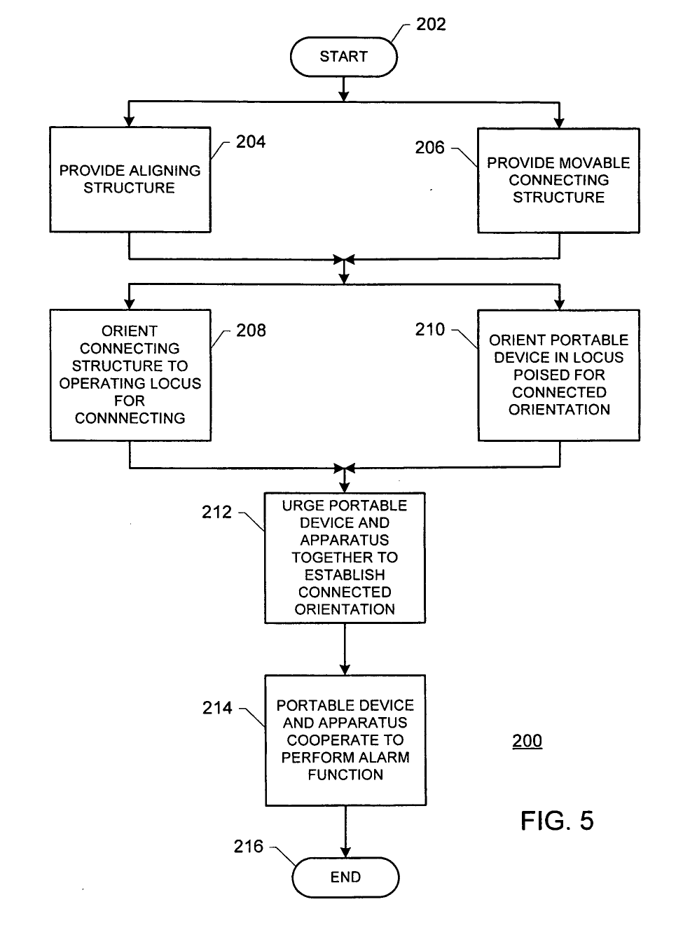

FIG. 5 is a flow chart illustrating the method of the present invention. In FIG. 5, a method 200 for configuring a receiving apparatus and a portable media player device to cooperatingly perform an accessory function begins at a START locus 202. The apparatus contains at least a portion of an accessory unit.

Method 200 continues with, in no particular order: (1) providing an aligning structure for positioning the portable media player device for effecting a connected orientation, as indicated by a block 204; and (2) providing a movable connecting structure for electrically connecting the portable media player device with the apparatus in the connected orientation, as indicated by a block 206.

Method 200 continues with, in no particular order: (1) orienting the connecting structure to an operating locus for effecting the electrical connecting with an extant model of the portable media device, as indicated by a block 208; and (2) orienting the portable media player device with respect to the aligning structure in a locus poised for effecting the connected orientation, as indicated by a block 210.

Method 200 continues with urging the portable media player device and the apparatus together to establish the connected orientation, as indicated by a block 212. The portable media player device cooperates with the apparatus to perform the accessory function when in the connected orientation, as indicated by a block 214. Method 200 terminates at an END locus 216.

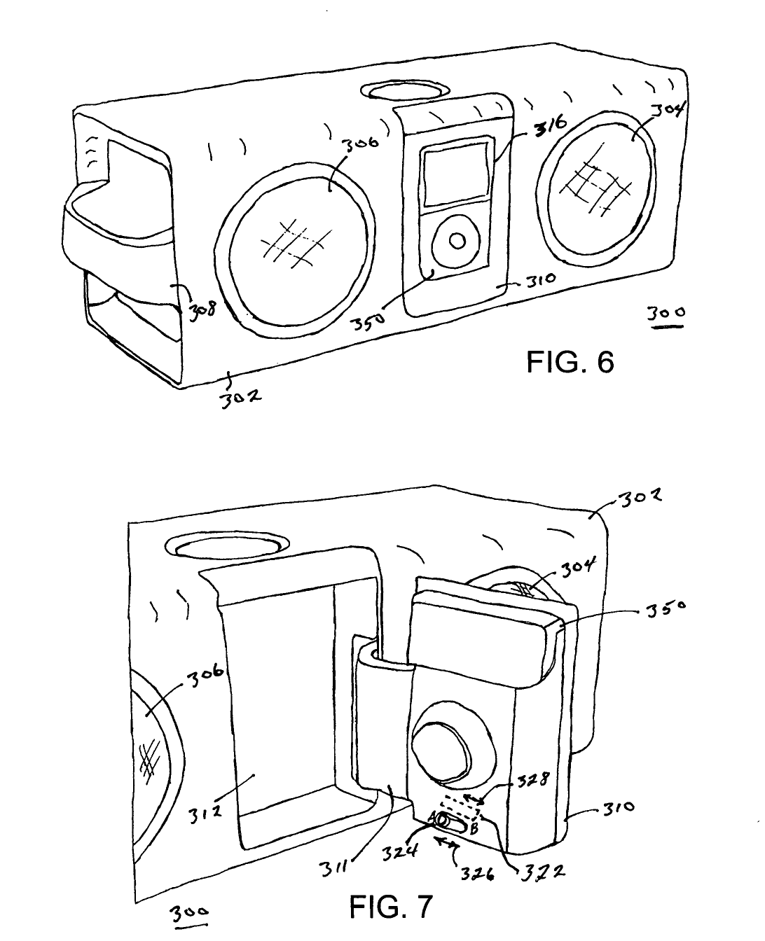

FIG. 6 is a perspective view of a second exemplary accessory unit configured according to the present invention. FIG. 7 is a perspective view of a portion of the second exemplary accessory unit illustrated in FIG. 6 with the door opened. Regarding FIGS. 6 and 7 together, a portable stereo or “boom box” accessory apparatus or unit 300 includes an enclosure 302, speakers 304, 306 mounted in enclosure 302 and a carrying handle 308. Carrying handle 308 may be integrally formed with enclosure 302 or attached with enclosure 302. An access portal or door 310 is configured for opening (FIG. 7) to expose an internal cavity 312 within enclosure 302. Affixed to door 310 is a receiving structure 314 in an appropriate orientation so that receiving structure 314 may be received within cavity 312 when door 310 is in a closed orientation (FIG. 6). Receiving structure 314 may be integrally formed with door 310. Door 310 swingingly coupled with enclosure 302 by a hinge 311 to facilitate swinging door 310 and receiving structure 314 between an open position (FIG. 7) and a closed position (FIG. 6).

Receiving structure 314 is configured to receive a portable media player device 350 in a connected orientation with a connecting structure 322 within receiving structure 314. Portable media player unit 350 is preferably visible when door 310 is in a closed orientation (FIG. 6) through an aperture 316 that traverses door 310. It is most preferred that a display 366 and operating controls 368 for portable media player device 350 be visible and accessible to a user through aperture 316 when door 310 is in a closed orientation (FIG. 6).

A selector structure 324 is coupled with connecting structure 322 (details not shown in FIGS. 6-7) so that moving selector structure 324 in directions indicated by arrows 326 will move connecting structure 322 in directions indicated by arrows 328. Connecting structure 322 is preferable configured substantially similar to connecting structure 322, described in connection with FIGS. 1-4. That is, connecting structure 322 is preferably embodied in an electrical connecting structure presenting a plurality of pins-or-sockets (see pins-or-sockets 22; FIG. 2) slidingly mounted in a slot (see slot 23; FIG. 2). The pins-or-sockets are arranged to facilitate a mating relationship with a complementary connecting structure presented by portable media player device 350 (not shown in FIGS. 6-7). The pins-or-sockets and the complementary connecting structure of portable media player device 350 cooperate to engage in a connected orientation in order to establish an electrical connection between accessory apparatus 300 and portable media player device 350. A variety of appropriate pins-or-sockets configurations for carrying out the arrangement required for effecting electrical coupling for the present invention are available and known to those skilled in the art. The pins-or-sockets in connecting structure 322 may be embodied in pins, embodied in sockets or embodied in a combination of pins and sockets as required for establishing an electrical connected or coupled orientation with a complementary connector structure provided for portable media player device 350. The pins-or-sockets are preferably carried on a shuttle unit (see shuttle unit 24; FIG. 2) that is movable within the slot to align with connecting structure of portable media player device 350 for establishing a connected relation between apparatus 300 and portable media player device. The shuttle unit may be mounted to provide an analog or continuous positioning capability of the shuttle unit within the slot. Alternatively, the shuttle unit may be mounted to provide discrete positioning capability of the shuttle unit within the slot to provide predetermined loci at which the shuttle unit may be oriented for connecting with portable media player device 350. Details of connecting unit 322 are not illustrated in FIGS. 6-7 in order to avoid cluttering FIGS. 6-7. The description of connecting unit 20 provided in connection with FIGS. 1-4 is considered sufficient for one skilled in the art to use for reproducing connecting structure 322 without undue experimentation.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. An apparatus configured for receiving a portable media player unit to cooperatively perform an accessory function with said portable media player unit in a connected orientation; said portable media player unit presenting at least one electrical connector structure; the apparatus containing at least a portion of an accessory unit; the apparatus comprising:
(a) a connecting structure for effecting electrical connecting with said at least one electrical connector structure to establish said connected orientation;
(b) a receiving structure configured for supporting said portable media player unit when the apparatus and said portable media player unit are in said connected orientation;
said connector unit being movable with respect to the apparatus to accommodate various orientations of said at least one electrical connector structure presented by various models of said portable media player unit in said connected orientation.

2. An apparatus configured for receiving a portable media player unit to cooperatively perform an accessory function with said portable media player unit in a connected orientation as recited in claim 1 wherein said receiving structure includes an attitude adjustment structure for adjusting attitude of said portable media player unit with respect to said connecting structure to achieve said connected orientation.

3. An apparatus configured for receiving a portable media player unit to cooperatively perform an accessory function with said portable media player unit in a connected orientation as recited in claim 1 wherein said accessory function includes at least one of an alarm function, an enhanced audio function, a video function or another digital function.

4. An apparatus configured for receiving a portable media player unit to cooperatively perform an accessory function with said portable media player unit in a connected orientation as recited in claim 1 wherein said portable media player unit has a generally parallelepiped shape; at least one face of said parallelepiped shape being accessible to a user when said portable media player unit is in said connected orientation.

5. An apparatus configured for receiving a portable media player unit to cooperatively perform an accessory function with said portable media player unit in a connected orientation as recited in claim 2 wherein said accessory function includes at least one of an alarm function, an enhanced audio function, a video function or another digital function.

6. An apparatus configured for receiving a portable media player unit to cooperatively perform an accessory function with said portable media player unit in a connected orientation as recited in claim 2 wherein said portable media unit has a generally parallelepiped shape; at least one face of said parallelepiped shape being accessible to a user when said portable media unit is in said connected orientation.

7. An apparatus configured for receiving a portable media player unit to cooperatively perform an accessory function with said portable media player unit in a connected orientation as recited in claim 3 wherein said portable media unit has a generally parallelepiped shape; at least one face of said parallelepiped shape being accessible to a user when said portable media unit is in said connected orientation.

8. An apparatus configured for receiving a portable media player unit to cooperatively perform an accessory function with said portable media player unit in a connected orientation as recited in claim 5 wherein said portable media unit has a generally parallelepiped shape; at least one face of said parallelepiped shape being accessible to a user when said portable media unit is in said connected orientation.

9. An apparatus for operating with a portable media player device to perform an accessory function; the apparatus containing at least a portion of an accessory unit; the apparatus comprising:
(a) an aligning structure for positioning said portable media player device for effecting a connected orientation;
(b) a connecting structure for electrically connecting said portable media player device with the apparatus in said connected orientation; said connecting structure being movable to at least two operating loci for effecting said electrical connecting with various models of said portable media device;
said portable media player device cooperating with the apparatus to perform said accessory function when in said connected orientation.

10. An apparatus for operating with a portable media player device to perform an accessory function for operating with a portable media player device to perform an alarm function as recited in claim 9 wherein said receiving structure includes an attitude adjustment structure for adjusting attitude of said portable media unit with respect to said connecting structure to achieve said connected orientation.

11. An apparatus for operating with a portable media player device to perform an accessory function as recited in claim 9 wherein said accessory function includes at least one of an alarm function, an enhanced audio function, a video function or another digital function.

12. An apparatus for operating with a portable media player device to perform an accessory function as recited in claim 9 wherein said portable media unit has a generally polyhedral shape; at least one face of said polyhedral shape being accessible to a user when said portable media unit is in said connected orientation.

13. An apparatus for operating with a portable media player device to perform an accessory function as recited in claim 10 wherein said accessory function includes at least one of an alarm function, an enhanced audio function, a video function or another digital function.

14. An apparatus for operating with a portable media player device to perform an accessory function as recited in claim 10 wherein said portable media unit has a generally polyhedral shape; at least one face of said polyhedral shape being accessible to a user when said portable media unit is in said connected orientation.

15. An apparatus for operating with a portable media player device to perform an accessory function as recited in claim 11 wherein said portable media unit has a generally polyhedral shape; at least one face of said polyhedral shape being accessible to a user when said portable media unit is in said connected orientation.

16. An apparatus for operating with a portable media player device to perform an accessory function as recited in claim 13 wherein said portable media unit has a generally polyhedral shape; at least one face of said polyhedral shape being accessible to a user when said portable media unit is in said connected orientation.

17. An engagement apparatus for effecting electrical coupling between a first device and a second device; said first device having a first coupler structure oriented generally about a first axis; said second apparatus receiving said first device in a coupled relation oriented generally about a second axis; said first axis and said second axis being substantially contained within a common plane; the apparatus comprising: a second coupler structure configured for effecting a substantially mating engagement with said first coupler structure; said second coupler structure being substantially symmetrically oriented with respect to said common plane; said second coupler structure being movable generally parallel with said common plane to a plurality of engagement loci for effecting said electrical coupling between said first device and said second device.

18. An engagement apparatus for effecting electrical coupling between a first device and a second device as recited in claim 17 wherein said first device may be embodied in one of a plurality of models; each respective model of said plurality of models having a respective said first axis; each said respective first axis being oriented at a respective displacement from said second axis when said respective first device is in said coupled relation with said second device; said second coupler structure being movable over a predetermined range; said predetermined range being at least equal with a maximum said respective displacement among a design selection of models of said plurality of models.

19. A method for configuring a receiving apparatus and a portable media player device to cooperatingly perform an accessory function; the apparatus containing at least a portion of an accessory unit; the method comprising the steps of:
(a) in no particular order:
(1) providing an aligning structure for positioning said portable media player device for effecting a connected orientation; and
(2) providing a movable connecting structure for electrically connecting said portable media player device with the apparatus in said connected orientation;
(b) in no particular order:
(1) orienting said connecting structure to an operating locus for effecting said electrical connecting with an extant model of said portable media device; and
(2) orienting said portable media player device with respect to said aligning structure in a locus poised for effecting said connected orientation; and
(c) urging said portable media player device and the apparatus together to establish said connected orientation; said portable media player device cooperating with the apparatus to perform said accessory function when in said connected orientation.

20. A method for configuring a receiving apparatus and a portable media player device to cooperatingly perform an accessory function as recited in claim 17 wherein said receiving structure includes an attitude adjustment structure for adjusting attitude of said portable media player device with respect to said connecting structure to achieve said connected orientation.
